(19) United States
(12) Patent Application Publication
(10) Pub. No.: US 2026/0028011 A1
(43) Pub. Date: Jan. 29, 2026

(54) Apparatus and Method for Mimicking the Operation of an Internal Combusion Engine Vehicle Transmission in an Electric Vehicle

(71) Applicant: Vincent Loccisano, Wellesley, MA (US)

(72) Inventor: Vincent Loccisano, Wellesley, MA (US)

(21) Appl. No.: 18/783,629

(22) Filed: Jul. 25, 2024

(51) Int. Cl. B60W 10/10; B60W 10/08

(52) U.S. Cl. CPC B60W 10/10; B60W 10/08; B60W 2540/14

(57) ABSTRACT

An apparatus includes electronic, mechanical and hardware enhancements to an electric vehicle to provide a virtual experience of controlling a manual transmission like that of an internal-combustion-engine-powered performance vehicle in an electronic vehicle.

### TECHNICAL FIELD

The present disclosure relates generally to electric vehicles and more specifically to the adaptation and arrangement of features common to internal combustion engine vehicles to create the experience of driving an internal combustion performance vehicle.

### BACKGROUND OF THE INVENTION

While electric vehicles (EVs) and hybrid vehicles offer environmental benefits by reducing greenhouse gas emissions and air pollution, some drivers find the driving experience to be unsatisfactory because there is little sensory feedback of the kind they are used to in traditional internal-combustion-engine (ICE) vehicles. Some consumers express a preference for the sound and vibration associated with traditional internal-combustion-engine (ICE) vehicles, whether out of nostalgia, a perception of a more engaging driving experience, or lack of feedback about vehicle performance in EVs.

Automobile electronics, including computers, electrical cables, and software protocols, are together known as a Controller Area Network (CAN), or CAN bus. A CAN is a vehicle's main computer system. Through the CAN bus, data travels through the system to the many subsystems such as those controlling the engine, the transmission, doors, windows, and other subsystems. Each of these subsystems is controlled by an electronic control unit (ECU). Current EVs may have fifty or more ECUs, each able to sense signals indicating, for example: acceleration at various angles; voltage; pressure; braking; vehicle roll and yaw; steering angle; temperature, and other variables. The CAN bus routes signals from sensors to computers as communicated by each ECU. An ECU can monitor voltage used by a subsystem and communicate that information through the CAN bus to actuate, for instance, stopping a power-sliding door from closing on a passenger's limb, or adjusting a fuel injector's performance.

Adding to or changing a vehicle's electronic features once required extensive wiring. With the development of CAN in the last forty years, feature development (such as adding passenger-controlled climate options) has become physically easier because each new feature can now be added by programming the new computer code into the CAN. Now, all vehicle features as well as vehicle diagnostics are controlled via CAN, which uses a standardized protocol called OBD-II. New features can be integrated into an EV by developing and uploading an algorithm into the vehicle's CAN.

Vehicle computer networks are now evolving to work with other network protocols, including Local Interconnect Networks (LIN) and FlexRay, which are network protocols designed for vehicles, as well as Ethernet.

Modern electric vehicles have software components allowing the suspension, driveline performance, and driver experience to be customizable for a variety of applications. For example, a modern EV may have an “eco” mode that offers greater distance range; a comfort mode that tunes the suspension to be compliant and smooth; and a high-performance mode that offers the best traction, acceleration and cornering performance.

Modern electric drivetrains offer high horsepower and near-instantaneous torque, depending on the size of the car's batteries and number of electric motors. Some EVs have four electric motors, one at each wheel, enabling advanced dynamic control such as torque and power vectoring. Because of this, previously impossible levels of performance, acceleration and speed, as well as control over individual systems, are now available.

The multiple motors of an EV's subsystems enable fine-tuning of vehicle dynamics and performance under braking, acceleration and cornering. Some EVs offer four-wheel steering, with both the front and rear wheels selectively steering in sometimes-different directions. Other controls, including steering ratio, brake-pedal response, accelerator response, horsepower and torque curves are readily changed in a modern EV, simply because they require no more than electronic inputs into the drivetrain and new algorithms downloaded to the vehicle CAN.

Multiple electric motors, coupled with brakes with gyroscopic sensors, as well as a variety of other additional existing inputs, allowing the dynamics of the vehicle chassis to be actively tuned or reprogrammed. This is possible in existing EVs and will become more feasible as these features are increasingly integrated into the development of future EVs.

Additionally, modern and near-future electric vehicles have greatly engineered vehicle dynamics, including highly customizable and tunable shock absorbers, roll bars, and dampers. Advanced vehicles also enable remotely adjustable settings for caster, camber, and ride height.

Modern and future EVs will soon enable finely tunable driver electronic inputs. Accelerator and brakes will no longer be physically connected to the corresponding systems of the vehicle; instead they will be electronic inputs controlled by a computer and ultimately delivered to the wheels. Modern EVs also require no physical gear-changing because these vehicles don't need a clutch or a manual transmission. Additionally, steering will be electronically rather than mechanically directed. For example, the Tesla Cyber Truck is the first mass-produced EV in which the steering wheel is a steer-by-wire system that is not rigidly connected to the turning wheels of the vehicle.

Patents and products in the current state of the EV art mimic some of the performance characteristics and exterior sounds of internal-combustion cars. Controls and customizability of the experience are limited and may not be feasible for all vehicle makes and models.

Other inventions delve into haptic feedback systems integrated into the steering wheel or pedals to simulate gear changes or engine response. While these patents address specific aspects of the driving experience, they lack a comprehensive approach to replicating the full sensory experience of an ICE car.

All these subsystems will be electronically operated through a central control that can be modified by a driver, but the loss of mechanical sound and feel may disappoint driving enthusiasts, who may come to view their EV as an appliance rather than a car.

ICEs have varying clutch designs with varying clutch-pedal actions. Some sports cars have heavier clutches intended for aggressive shifting, with a clutch pedal that is “heavier” or harder to push. In other ICE sports cars, a clutch pedal may have a higher friction point than a daily commuter car.

A magnetorheological damper or magnetorheological shock absorber is a damper filled with magnetorheological fluid which is in turn controlled by an electro-magnetic field. The damping characteristics of the damper may be continuously controlled by varying the power of the electromagnet.

Micro-electromechanical systems (MEMS) is a field of technology of microscopic devices that incorporate both electronic and moving parts. Some examples of MEMS have piezoelectrics that impart small forces or sound waves, as well as accelerometers that measure relative movement; and MEMS gyroscopes that measure changes in orientation.

A servomotor is a rotary or linear actuator that allows for precise control of angular or linear position, velocity and acceleration in a mechanical system. A servomotor is a closed-loop servomechanism that uses position feedback, either linear or rotational, to control motion and final position.

Torque curve is a measure of the torque of an engine against the rotational velocity of the engine output. Electric motors have a very different torque curve than internal combustion engines. Internal combustion engines exhibit maximum torque at higher velocities where electric motors have maximum torque at very low velocities.

While a torque curve measures the rotational force produced by an engine and therefore the engine's ability to perform work, a horsepower curve measures how fast an engine can perform work. High torque results in fast acceleration from a stop while high horsepower results in a high top speed.

A customizable and adaptable system that caters to the preferences of car enthusiasts would offer a responsive, sensory experience mimicking shifting and operating a clutch like that of performance ICE cars.

### SUMMARY OF THE INVENTION

A method and apparatus includes electronic, mechanical and hardware enhancements to an electric vehicle to provide a virtual experience of controlling a manual transmission in a stock EV.

In each iteration, driver inputs are mapped to existing controls that output those replicating the model of choice. Specifically, for example, the driver might experience the act and haptic experience of shifting gears. For example, in an electric vehicle virtually shifting into a forward gear, reverse gear, or neutral gear may produce sounds played through the electric vehicle sound system to mimic the shifting of gears of an ICE-vehicle transmission. Linear-motion actuators connected to the gear shift and residing along a perpendicular axis may be programmed to provide resistance and/or vibration through the gear shift to provide haptic feedback to mimic the feel of shifting an ICE vehicle gearshift. Some manufacturers may include two or more axes about which a gear shift in an EV may move. In one example, lateral motion moves the EV from a forward gear, to neutral, to reverse; while forward and rearward movement increases or decreases torque to mimic upshifting and downshifting like that of an ICE vehicle transmission. Actuators may also provide the action of pushing downward against resistance to shift into reverse as is common in an ICE-vehicle transmission.

Further, vibration may also be provided when the vehicle is improperly shifted. For example, although most EVs are configured so that shifting into reverse while moving forward does not improperly engage the electric motor, vibration may be sent through the gear shift to mimic the effect of grinding gears in an ICE vehicle transmission. The apparatus may further be coupled with the electric vehicle controller-area network to control the EV motor to provide less torque at an example speed that would be in the lower range of a gear in an ICE vehicle, and relatively greater torque at a speed that would be in the higher range of a gear in the same ICE vehicle. Actuators may also provide resistance to guide the movement of the gear shift. Some ICE vehicles have transmissions where a gear shift is free to move over a relatively large portion of the H-pattern and providing resistance only when finding and engaging a gear. Others have mechanically gated gear shifts that follow very precise motion. The distance between engaged gears and the amount of free movement between engaged gears may be mimicked by precise control of the actuators.

In other embodiments, a gear shift and clutch pedal are added as after-market accessories to the vehicle. Coordinating with the gear shift, the clutch pedal may be programmed to mimic the sound and effect of the motor shifting between gears.

The gear shift and clutch pedal mimic the feel of a specific performance ICE vehicle without a mechanical connection to a transmission. Instead, linkage members, electronic resistance, and the embodiment's software modification together mimic the feel of a gear shift and a clutch pedal.

In some embodiments the gear shift is guided to move in an H-pattern common to an ICE vehicle's manual-transmission gear shifts. A gear shift may be connected to a linkage that allows the gear shift to move in an H-pattern common to ICE vehicle transmissions. A first linear actuator may control movement of the linkage in a first direction and a second linear actuator may control movement in a second direction, perpendicular to the first linear actuator. Electronic pulses from the EV electronic control unit may be configured to provide varying resistance in two axes. Varying resistance on two axes may provide vibration, resistance and free movement to the linkage and to the gear shift. Free movement and resistance may be varied to mimic the movement and feel of specific ICE-vehicle transmissions, while vibration may mimic mis-shifts.

The method and apparatus's algorithm may be downloaded into any of an EV's ECUS, CAN, LIN, or Ethernet platform to simulate aspects of an ICE engine and transmission and clutch-pedal and gear-shift response to user inputs.

In an iteration, a driver may choose an aftermarket, downloadable “vehicle pack” or modification set, which employs the apparatus and method, to make the modifications. Here an EV driver has additional control over each input. For example, they may want to “shift” gears without employing a clutch. In this case the driver would turn off a “use clutch input” command, and the EV would handle virtual shifting without the use of a virtual clutch, replicating an act of smooth shifting.

A driver wishing to enable, for example, automatic double-clutching or rev-matching between gear changes but does not want to do it themselves using a clutch and throttle, would choose an input (a button or other device) to achieve that end.

In another embodiment, a vehicle manufacturer maps its factory-supported, brand-specific system commands to the algorithms of the method and apparatus to render the EV into an immersive ICE simulation that is layered over EV technology. For example, a driver interested in replicating the experience of shifting gears in a 1960s Jaguar would use the method and apparatus to modify the factory-provided CAN so that it responds to movement of a gear shift and clutch pedal to control the motor and in some embodiments to create sound effects that simulate that experience.

In one example, a clutch pedal and gear shift are fitted into an EV so that the driver experiences the act and haptic experience of shifting gears. The clutch pedal may be programmed to move in a manner that requires similar force and provides a similar feel of a friction point. During this action, the apparatus and method sends specific audio over the vehicle's sound system to mimic the sound and feel of a motor shifting between gears. The apparatus and method would mimic the stiffness and friction point location of a specific ICE clutch pedal, for example, as well as the feel and response of a gear shift.

Similarly, the embodiment simulates the haptic experience of a clutch pedal, with electrical signals input to the vehicle's CAN to create a feel of a virtual clutch pedal, adjustable by electronic resistance changes through the inputs into the embodiment's driver interface. A mis-shift is met with, for example, the sound of grinding gears and the feeling of a bucking vehicle. Additionally, in this embodiment, a driver could virtually “stall” the vehicle by letting out the virtual clutch too quickly, causing the motor to imitate the feel of a stall while maintaining a safe speed.

In other embodiments the apparatus is coupled with the electric vehicle controller-area network to control the vehicle onboard sound system to mimic the sound and vibration of an

ICE-vehicle transmission as it would sound and feel when transitioning from the low end to the high end of a gear. Similarly, the torque curve and horsepower curve of the ICE-vehicle engine may be mimicked by reducing electric motor torque at slower speeds and increasing torque at higher speeds, particularly within mimicked gear ranges. One skilled in the art understands that an ICE motor and transmission experiences lower torque at low speeds and at lower ranges of each gear. Mimicking gear ratios may be accomplished by setting a range of speeds under which the EV would mimic each gear like the way that an ICE vehicle operates optimally in given gears at given speeds.

In some embodiments, to accurately represent an ICE vehicle of a driver's choosing, the weight of a virtual clutch pedal, the location along the clutch pedal stroke of the friction point, and other aspects may be adjusted through an electronic resistance change indicated by driver input. Depending on performance-car preference, one may choose a stiff-clutch or lighter-touch effect. A driver may choose, for example, between a street version of a performance ICE or a track-ready version with a heavier clutch and higher friction point.

In some embodiments, the force required to press the clutch or move the gear shift is controlled by electronic resistance. In one example, a clutch pedal is a simple arm that is mounted to a pivot at one end and a pedal at the other end. Movement of the arm is controlled electronically. In one embodiment, the force required to press the clutch, the travel distance and the feel of a friction point are controlled by a magnetorheological damper. Software controls electromagnetism that is applied to the magnetorheological fluid in the damper to control the stiffness of the clutch, to mimic the location of a friction point in a clutch, and to mimic the distance of travel required to shift gears.

While a clutch pedal may be controlled by a single controller, a gear shift may be controlled by a set of controllers to mimic the number of gears; the shift pattern and the stiffness; the distance of travel; and the general feel of the shift of a specific ICE performance cars. In one example, the X-axis of a shift is controlled by a first set of electronic force applicators, while the Y-axis is controlled by a second set of electronic force applicators. One skilled in the art understands that various electronic components may be employed to impart a force on a shift lever, including magnetorheological dampers and servomotors. Mechanical location of the shift position may be controlled by various sensors, including micro-electromechanical mechanical systems (MEMS) such as accelerometers and gyroscopes, to track the movement of the shift. In other embodiments a miniature camera and digital image inform a software-controlled positioning system. In other embodiments, servomotors may be used to track and control movement of mechanical linkage.

In some embodiments, a tachometer is shown on the EV visual dashboard display. EVs LCD displays differ from ICE displays, which commonly have dials, knobs and switches. In an embodiment, a visual representation of a tachometer may be displayed on an LCD and may be electrically coupled with the shift and clutch to demonstrate the movement of a tachometer during the shifting process.

The virtual clutch and gear shift system affects alternative operational effects in day-to-day driving. For example, the apparatus and method enables various modes: while switched to a normal, “EV-driving mode,” the embodiment's EV shifter may be mapped with pre-set controls. For example, a driver may like the gear shift to control the interior climate system, while the clutch controls the choice of music; when switched to “replica mode,” the clutch pedal and gear shift work together to simulate the changing of virtual gears.

### BRIEF DESCRIPTION OF DRAWINGS

FIG. 1 is a perspective view of a gear shift of the disclosure.

FIG. 2 is a cutaway view of the apparatus of FIG. 1.

FIG. 3 is a perspective view of a clutch pedal of the disclosure

FIG. 4 is a diagram of a method of using the apparatus

### DETAILED DESCRIPTION

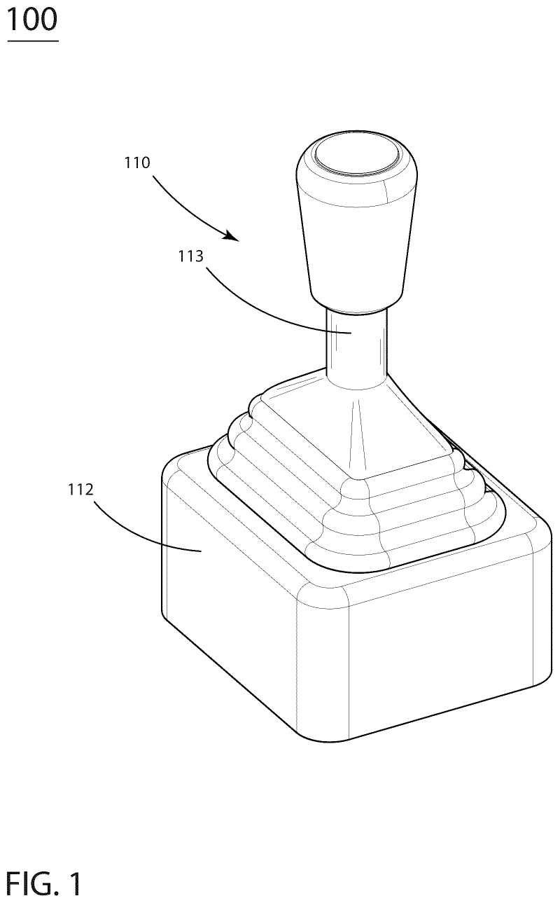

FIG. 1 shows an apparatus of the embodiment 100 with a gear shift 110, a shift lever 114 and a housing 112. The housing 112 has mechanical and electrical components that mimic the feel of an actual gear shift without being connected to an actual transmission. The apparatus 100 is intended to be mounted in an EV in a way that mimics the location of a gear shift in an ICE performance vehicle. One skilled in the art understands that a variety of styles and shapes may imitate specific ICE performance vehicle gear shifts.

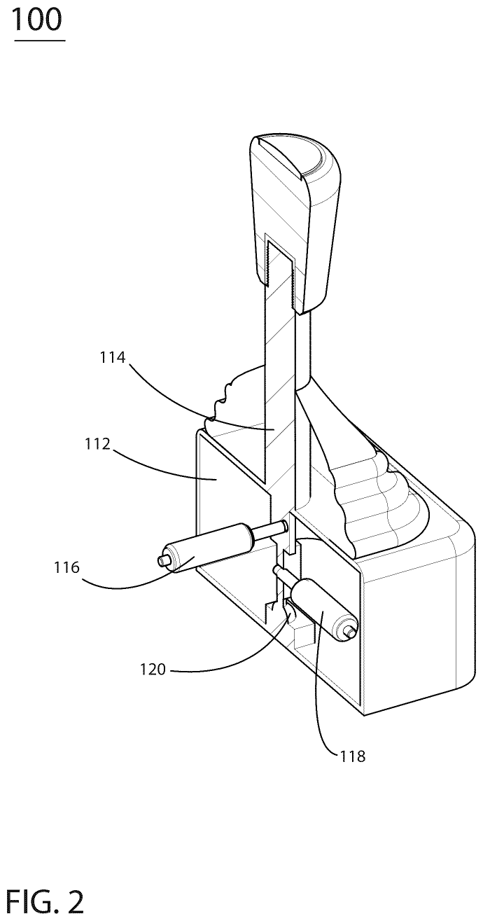

FIG. 2 shows an example embodiment 100 of the electrical and mechanical components in the housing 112 of the gear shift 110. The shift lever 114 is mounted on a pivot 120. A first electro-mechanical actuator 116 controls movement of the shift lever 114 laterally, (to the left and right of the user). A second electro-mechanical actuator 118 controls movement of the shift lever 114 fore and aft of the user. In some embodiments, electro-mechanical actuators are rheological dampers. One skilled in the art understands that a rheological damper may be controlled by an electrical charge to stiffen or free the movement of the damper in real time. A rheological damper may instantaneously stiffen the movement of the shift lever 114, for example, to imitate the extent of movement to mimic the feel of a gear shift in a specific ICE performance vehicle. Furthermore, specific shift patterns can be mimicked by a software-controlled electrical signal. Location of the shift lever 114 is monitored by the extent of the stroke of the electro-mechanical actuators 116, 118 so that the specific location of the shift lever may be determined by a control software. One skilled in the art understands that a variety of electro-mechanical actuators may be employed to control movement of a lever.

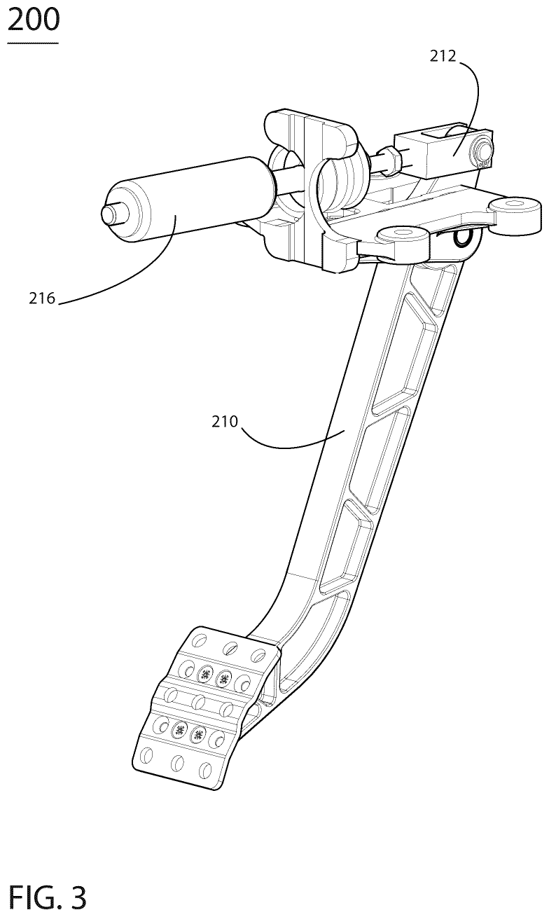

FIG. 3 shows a perspective view of an example embodiment 200 of a clutch pedal 210. The apparatus 200 is intended to be mounted in an EV in a way that mimics the location of a clutch pedal in an ICE performance vehicle. One skilled in the art understands that a variety of styles and shapes may imitate specific ICE performance vehicle clutch pedals. The clutch pedal 210 moves on a pivot 220 and then moves a linkage 212 that moves in the opposite direction of the clutch pedal. An electro-mechanical actuator 216 controls the movement of the linkage 212 and hence the clutch pedal 210. The force required to move the pedal is controlled by electro-mechanical actuator 216 and therefore can mimic the amount of force required to move specific clutch pedals from specific ICE performance vehicles. For example, a slight stiffening of the movement of the clutch pedal may be used to mimic the feel of the friction point of a clutch, wherein an actual clutch begins to contact a flywheel. One skilled in the art understands that a variety of electro-mechanical actuators may be employed to control movement of a lever.

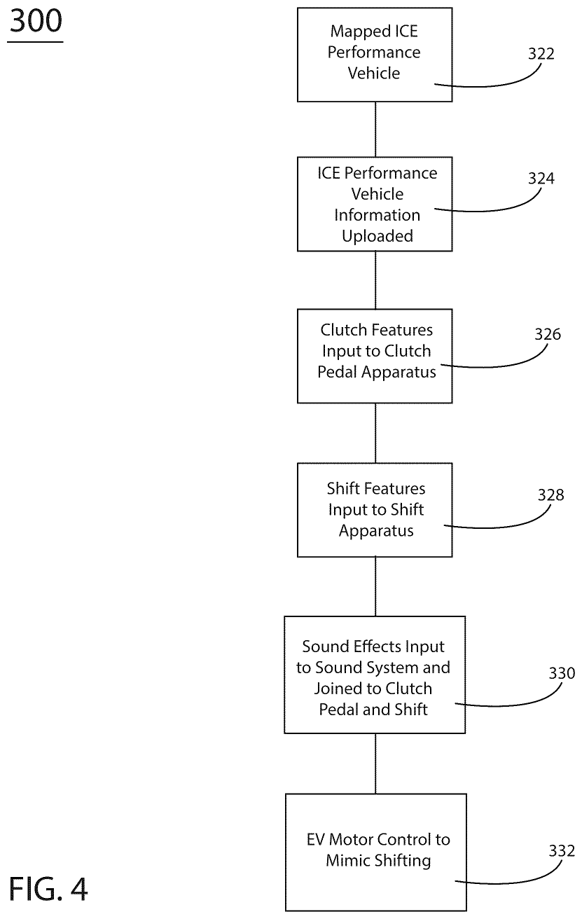

FIG. 4 shows a diagram 300 of a method for using the apparatus of FIG. 1, FIG. 2 and FIG. 3. An ICE performance-vehicle characteristics that relate to clutching and shifting are mapped 322. The stiffness of the clutch movement, the length of the stroke of the clutch, the location of the friction point and the like are measured and recorded. The number of gears, the gear-shift pattern, the distance of movement between gears and the resistance of the movement of the gear shift are also mapped. The mapped information is stored in the embodiment's software. The mapped ICE performance vehicle information is uploaded to an EV central control system such as the CAN BUS 324. Clutch features are input to the apparatus 200 to set parameters according to the mapped ICE performance vehicle clutch characteristics 326. Gear-shift features are input to the apparatus 100 to set parameters according to the characteristics of the mapped, ICE-performance-vehicle gear shift 328. The embodiment's sound effects communicate with both the clutch and shift components 330. The software further controls the EV motor within safe operating limitations to control the motor to mimic the shifting of gears 332 of an ICE transmission. One skilled in the art understands that an electric motor driven at the same speed that the vehicle is traveling may mimic the feel of putting an ICE transmission in neutral, or that down-shifting without braking may be mimicked by using the motor as a generator as when regenerative braking is engaged.

The apparatus and method may influence the control of various systems in the EV. When shifting appropriately for the mimicked ICE, the user may experience the feel of the shift and clutch, and the sound of the motor when shifting and accelerating within the range of each gear. The user may also experience the gear shift not moving when the clutch is not depressed, or the sound of gears grinding if the process of clutching and shifting is improperly done. The apparatus and method may also mimic the feel of a motor stalling if the process in done improperly, within the limits of safety. Electronic controls may reduce power and intermittently power the motor to cause a vibration, for example, to mimic the feel an ICE when shifting into a high gear at too low a speed.

1. An apparatus for mimicking the operation of an internal combustion engine transmission for use in an electric vehicle, the apparatus comprising:
a gear shift in said electric vehicle, electronically coupled to an electric vehicle electronic control unit and further electronically coupled with a controller area network; wherein
movement of said gear shift sends signals through said electronic control unit to said controller area network to control aspects of said electric vehicle dynamics that mimic internal combustion vehicle transmission dynamics.

2. The apparatus of claim 1 further comprising:
a first actuator movably engaged with said gear shift along a first axis; and
said actuator provides resistance and guidance to mimic the feel of moving a gear shift in the internal combustion engine transmission.

3. The apparatus of claim 2 further comprising:
a second actuator movably engaged with said gear shift along a second axis wherein the first axis is perpendicular to the second axis; wherein
said actuators mimic the play and engagement of internal combustion engine transmission gear shifts.

4. The apparatus of claim 3 wherein:
said first and second actuator are configured to create vibration to mimic the internal combustion engine transmission when miss-shifted to mimic gear grinding when improper shifting has occurred.

5. The apparatus of claim 1 wherein:
the apparatus is coupled with the electric vehicle controller area network to control a sound system in said electric vehicle to mimic the sound of said internal combustion vehicle transmission transitions from a low end of a gear to a high end of a gear.

6. The apparatus of claim 1 wherein:
the apparatus is coupled with the electric vehicle controller area network to control an electric motor and a sound system in said electric vehicle to mimic the torque curve and sound of said internal combustion vehicle transmission transitions from a low end of a gear to a high end of a gear.

7. The apparatus of claim 1 wherein:
the apparatus is coupled with the electric vehicle controller area network to control an electric motor and a sound system in said electric vehicle to mimic the horsepower curve and sound of said internal combustion vehicle transmission transitions from a low end of a gear to a high end of a gear.

8. The apparatus of claim 1 wherein:
the apparatus is coupled with the electric vehicle controller area network to control at least one motor in said electric vehicle to provide relatively less torque after movement of said gear shift and relatively greater torque as speed increases after movement of said gear shift.

9. The apparatus of claim 1 further comprising:
an after-market gear shift configured to be mounted in said electric vehicle having a shift lever pivotably engaged with a housing; and
electronic measurement equipment configured to track movement of said after-market gear shift, is electronically coupled to, and sends signals through, the electronic vehicle electronic control unit and further electronically coupled with the electric vehicle controller area network; wherein
the after-market gear shift sends signals to the sound system of the electric vehicle to produce the sound of shifting the internal combustion engine transmission.

10. The apparatus of claim 9 wherein:
said after-market gear shift is electronically coupled to said electronic control unit by way of OBD-II.

11. The apparatus of claim 9 wherein:
said after-market gear shift is electronically coupled to said electronic control unit by way of Bluetooth.

12. The apparatus of claim 9 wherein:
when not in use to mimic shifting the internal combustion engine transmission, the apparatus is coupled with the electric vehicle controller-area network to enable a user to set the control of features and functions of the electric vehicle depending on the position of the gear shift.

13. The apparatus of claim 9 further comprising:
first actuator movably engaged with said gear shift along a first axis; and
a second actuator movably engaged with said gear shift along a second axis, wherein: the first axis is perpendicular to the second axis; and
each actuator provides resistance and guidance to mimic the feel of moving a gear shift in the internal-combustion-engine transmission.

14. The apparatus of claim 9 wherein:
said after-market shifter further functions to shift the gears of the electric vehicle.

15. The apparatus of claim 12 wherein:
said first and second actuator provide resistance to mimic the action of pushing down on the shifter to access a reverse gear.

16. The apparatus of claim 9 further comprising:
said gear shift is generally movable in an H-pattern.

17. The apparatus of claim 9 wherein:
said actuators are configured to provide varying resistance to provide haptic feedback to mimic the free movement and physical engagement of gears in specific internal-combustion-engine transmissions.

18. The apparatus of claim 9 further comprising:
a linkage pivotally engaged with a clutch pedal, configured to be mounted proximal to accelerator and decelerator pedals in an electric vehicle, and
electronic-measurement equipment configured to track movement of said clutch pedal is electronically coupled to, and sends signals through, the electric-vehicle electronic control unit and further electronically coupled with the electric vehicle controller-area network; wherein
movement of said clutch pedal sends signals through said electronic control unit to said controller-area network to control aspects of the electric vehicle functions.

19. The apparatus of claim 18 further comprising:
the apparatus is coupled with the electric vehicle controller-area network to control a sound system in said electric vehicle to mimic the sound of shifting of gears of an internal-combustion-engine manual transmission according to movement of the clutch pedal.

20. The apparatus of claim 18 further comprising:
a clutch-actuator movably engaged with said linkage along a first axis; and
said actuator provides resistance to mimic the resistance of a similar clutch pedal in the internal combustion engine transmission when depressing said clutch and vibration when releasing said clutch.

21. The apparatus of claim 18 further comprising:
said actuator provides resistance to mimic the free movement and engagement point of a similar clutch pedal in the internal-combustion-engine transmission.

22. The apparatus of claim 18 further comprising:
the linkage is coupled with the electric vehicle controller area network to enable a user to set the control of features and functions of the electric vehicle depending on the position of the clutch pedal.
